(19) United States
(12) Patent Application Publication
(10) Pub. No.: US 2011/0252324 A1
(43) Pub. Date: Oct. 13, 2011

(54) USER PARTICIPATION RANKING OF VIDEO EVENTS

(76) Inventor: MARC A. TODD, Foxboro, MA (US)

(21) Appl. No.: 12/757,460

(22) Filed: Apr. 9, 2010

(51) Int. Cl. G06F 3/00; H04H 60/33

(52) U.S. Cl. 715/717; 725/9

(57) ABSTRACT

A relative viewer interaction level is determined for each of a plurality of video events. An interaction ranking is associated with each of the plurality of video events based upon the relative viewer interaction level for each of the plurality of video events. A video event listing is generated, generally contemporaneously with the plurality of video events. The video event listing based upon, at least in part, the associated interaction ranking of each of the plurality of video events.

### TECHNICAL FIELD

The present disclosure generally pertains to video events, and more particularly relates to video event listings.

### BACKGROUND OF THE DISCLOSURE

The extraordinary proliferation of television eventing has resulted in an immense amount of television programming. In many regions there may be hundreds of channels of available television content available to viewers. Such a vast array of available viewing options at any given time can often make it challenging for viewers to find a program that they may most enjoy watching. While channel and program listings are often providing by television service providers, the lengthy listings do little to aid viewers in making their watching decisions. As such, viewers often resort to channel surfing as the most viable means of finding the show that holds the greatest entertainment potential. However, channel surfing results in a great deal of wasted time, and may give rise to a disjointed viewing experience, as the viewer continually changes from channel to channel.

### SUMMARY OF THE DISCLOSURE

According to a first implementation a computer implemented method includes determining, by a computing device, a relative viewer interaction level for each of a plurality of video events. The computer implemented method also includes associating, by the computing device, an interaction ranking with each of the plurality of video events based upon the relative viewer interaction level for each of the plurality of video events. The computer implemented method further includes generating, by the computing device, a video event listing, generally contemporaneously with the plurality of video events, the video event listing based upon, at least in part, the associated interaction ranking of each of the plurality of video events.

One or more of the following features may be included. The plurality of video events may include a plurality of generally contemporaneous television video events. The viewer interaction may include viewer interaction on one or more webpages associated with one or more of the plurality of video events. The viewer interaction may include accessing the one or more webpages associated with one or more of the plurality of video events. The viewer interaction may include social interaction between a plurality of viewers on the one or more webpages associated with one or more of the plurality of video events.

The computer implemented method may include publishing, by the computing device, the video event listing via at least one webpage associated with one or more of the plurality of video events. The computer implemented method may include updating the interaction ranking associated with each of the plurality of video events; and generating an updated video event listing based upon, at least in part, the updated interaction ranking associated with each of the plurality of video events.

According to a second implementation, a computer program product includes a computer readable medium having a plurality of instructions stored on it. When executed by a processors, the instructions cause the processor to perform operations including determining a relative viewer interaction level for each of a plurality of video events. An interaction ranking is associated with each of the plurality of video events based upon the relative viewer interaction level for each of the plurality of video events. A video event listing is generated, generally contemporaneously with the plurality of video events, the video event listing based upon, at least in part, the associated interaction ranking of each of the plurality of video events.

One or more of the following features may be included. The plurality of video events may include a plurality of generally contemporaneous television video events. The viewer interaction may include viewer interaction on one or more webpages associated with one or more of the plurality of video events. The viewer interaction may include accessing the one or more webpages associated with one or more of the plurality of video events. The viewer interaction may include social interaction between a plurality of viewers on the one or more webpages associated with one or more of the plurality of video events.

Instructions may be included for publishing the video event listing via at least one webpage associated with one or more of the plurality of video events. Instructions may be included for updating the interaction ranking associated with each of the plurality of video events; and generating an updated video event listing based upon, at least in part, the updated interaction ranking associated with each of the plurality of video events.

According to another implementation, a system includes a processor, and a memory coupled with the processor. A first software module is executable by the processor and the memory. The first software module is configured to determine a relative viewer interaction level for each of a plurality of video events. A second software module is executable by the processor and the memory. The second software module is configured to associate an interaction ranking with each of the plurality of video events based upon the relative viewer interaction level for each of the plurality of video events. A third software module is executable by the processor and the memory. The third software module configured to generate a video event listing, generally contemporaneously with the plurality of video events, the video event listing based upon, at least in part, the associated interaction ranking of each of the plurality of video events.

One or more of the following features may be included. The plurality of video events may include a plurality of generally contemporaneous television video events. The viewer interaction may include viewer interaction on one or more webpages associated with one or more of the plurality of video events. The viewer interaction may include accessing the one or more webpages associated with one or more of the plurality of video events. The viewer interaction may include social interaction between a plurality of viewers on the one or more webpages associated with one or more of the plurality of video events.

The system may also include a fourth software module that may be executable by the processor and the memory The fourth software module may be configured to publish the video event listing via at least one webpage associated with one or more of the plurality of video events. The system may also include a fifth software module that may be executable by the processor and the memory. The fifth software module may be configured to update the interaction ranking associated with each of the plurality of video events; and generating an updated video event listing based upon, at least in part, the updated interaction ranking associated with each of the plurality of video events.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a event listing process coupled to a distributed computing network.

FIG. 2 is a flowchart of a process performed by the event listing process of FIG. 1.

FIG. 3 is a diagrammatic view of a web page including a event listing.

### DETAILED DESCRIPTION OF EXEMPLARY EMBODIMENTS

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable (i.e., computer-usable) medium(s) having computer-usable program code embodied thereon.

Any combination of one or more computer-readable medium(s) may be utilized. The computer-readable medium include a computer-readable storage medium, which may be, for example, but is not limited to, an electronic, magnetic, optical, electromagnetic, infrared, or semiconductor system, apparatus, a device, or any suitable combination of the foregoing. Exemplary computer readable storage medium may include, but is not limited to, a portable computer diskette, a hard disk, a solid state disc drive, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any medium that can contain, or store a program for use by or in connection with an instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on a single computing device, e.g., as a stand-alone software package, and or may be at least partly executed on multiple computing devices that may be remote to one another. In the latter scenario, remote computing devices may be connected to one another through a local area network (LAN) or a wide area network (WAN), or the connection may be made to one or more remote computing devices (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

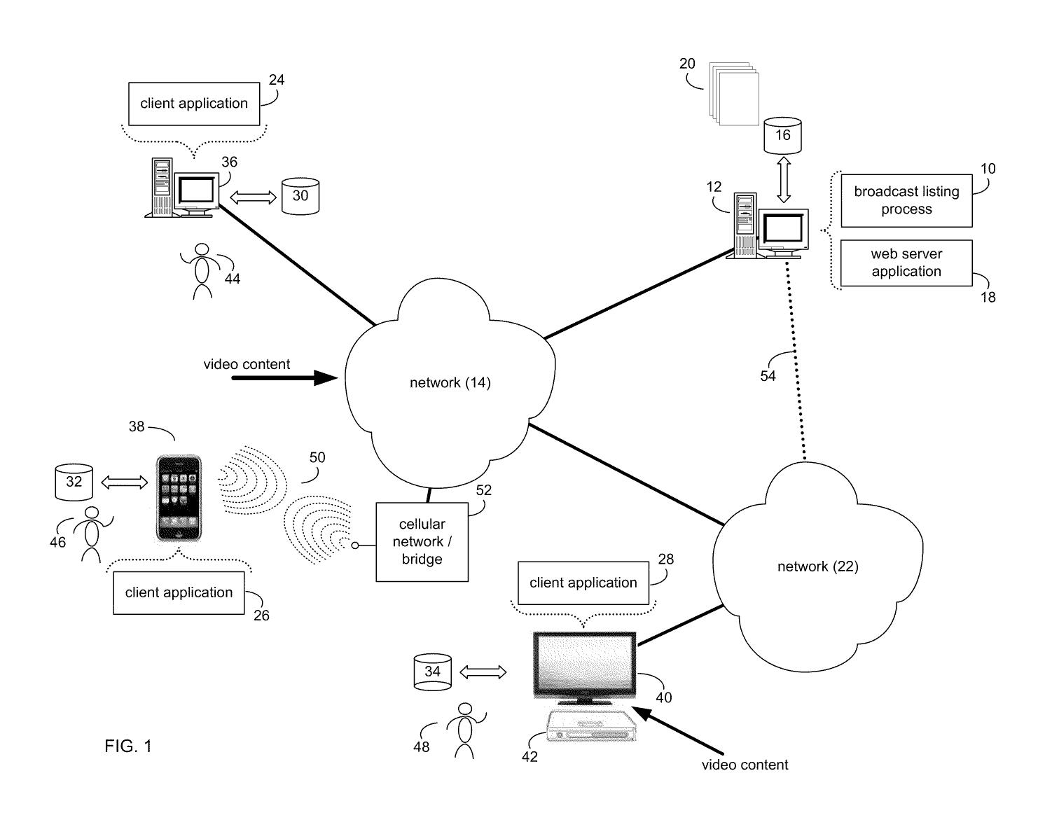

Referring to FIG. 1, there is shown event listing process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows® XP Server; Novell® NetWare®; or Red Hat® Linux®, for example (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both), for example.

As will be discussed below in greater detail, event listing process 10 may determine a relative viewer interaction level for each of a plurality of video events. An interaction ranking may be associated with each of the plurality of video events based upon the relative viewer interaction level for each of the plurality of video events. Event listing process 10 may also generate a video event listing, generally contemporaneously with the plurality of video events, the video event listing based upon, at least in part, the associated interaction ranking of each of the plurality of video events.

The instruction sets and subroutines of event listing process 10, which may include one or more software modules, and which may be stored on storage device 16 coupled to server computer 12, may be executed by one or more processors (not shown) and one or more memory modules (not shown) incorporated into server computer 12. Storage device 16 may include but is not limited to: a hard disk drive; a solid state drive, a tape drive; an optical drive; a RAID array; a random access memory (RAM); and a read-only memory (ROM).

Server computer 12 may execute web server application 18, examples of which may include but are not limited to: Microsoft IIS, Novell Webserver™, or Apache® Webserver, that allows for HTTP (i.e., HyperText Transfer Protocol) access to server computer 12 via network 14 (Webserver is a trademark of Novell Corporation in the United States, other countries, or both; and Apache is a registered trademark of Apache Software Foundation in the United States, other countries, or both), hosting of one or more web pages (e.g., web pages 20) and/or one or more web sites (each including one or more web pages, e.g., web pages 20), and the like. Network 14 may be connected to one or more secondary networks (e.g., network 22), examples of which may include but are not limited to: a local area network; a wide area network; or an intranet, for example.

One or more client applications (e.g., client applications 24, 26, 28) may interact with web pages 20 (e.g., via web server application 18 and/or event listing process 10). One or more of web pages 20 may be associated with one or more video events. Client applications 24, 26, 28 may include, for example, a web browser, and instant messaging application, a voice over IP application, a video over IP application, or the like. Event listing process 10 may monitor and/or obtain data relating to interactions between client applications 24, 26, 28 and web pages 20. Event listing process 10 may be a standalone application. Additionally/alternatively, event listing process 10 may interact with web server application 18 and/or may be incorporated into web server application 18 as a module or component of web server application.

The instruction sets and subroutines of client applications 24, 26, 28, (which may include one or more software modules) which may be stored on storage devices 30, 32, 34 (respectively) coupled to computing devices 36, 38, 40/42 (respectively), may be executed by one or more processors (not shown) and one or more memory modules (not shown) incorporated into computing devices 36, 38, 40/42 (respectively). Storage devices 30, 32, 34 may include but are not limited to: hard disk drives; solid state drives, tape drives; optical drives; RAID arrays; random access memories (RAM); read-only memories (ROM), compact flash (CF) storage devices, secure digital (SD) storage devices, and a memory stick storage devices. Examples of computing devices 36, 38, 40/42 may include, but are not limited to, personal computer 36, mobile computing device 38 (which may include, but is not limited to, a personal digital assistant, a data capable cellular telephone, a portable video game device, and the like), and television 40 and/or television set-top box 42. Computing devices 36, 38, 40/42 may be capable of being connected to a data network (e.g., network 14, network 20). Further, in some embodiments, computing devices 36, 38, 40/42 may be capable of rendering video content (e.g., video events) and/or may be associated with the rendering and/or consumption of video content.

As mentioned above, using computing devices 36, 38, 40/42 users 44, 46, 48 may interact with web pages 20 (e.g., via web server application 18 and/or event listing process 10). The various computing devices may be capable of being directly or indirectly coupled to network 14 (or network 22). For example, personal computer 36 is shown directly coupled to network 14 via a hardwired network connection. Similarly, a personal computer (such as a laptop computer) may be wirelessly coupled to network 14 (or network 22) via a wireless communication channel established between the laptop computer and a wireless access point (i.e., WAP), which may be coupled to network 14. The WAP may be, for example, an IEEE 802.11a, 802.11b, 802.11g, Wi-Fi, and/or Bluetooth device that is capable of establishing the wireless communication channel between the laptop computer and the WAP. Mobile computing device 38 is shown wirelessly coupled to network 14 via wireless communication channel 50 established between mobile media device 38 and cellular network/bridge 52, which is shown directly coupled to network 14. Additionally, server computer 12 may be coupled to network 22, e.g., as shown via phantom line 54.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Computing devices 36, 38, 40/42 may each execute an operating system, examples of which may include but are not limited to Microsoft Windows, Microsoft Windows CE®, iPhone OS, Android, Red Hat Linux, etc., or a custom operating system (Windows CE is a registered trademark of Microsoft Corporation in the United States, other countries, or both).

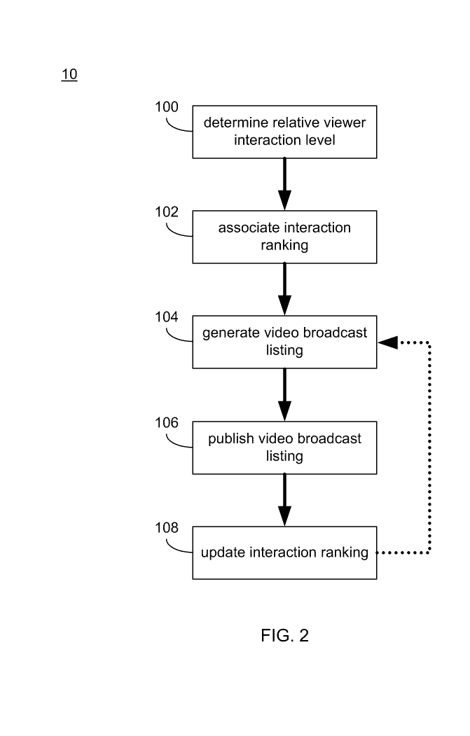

Referring also to FIG. 2, as discussed above, event listing process 10 may determine 100 a relative viewer interaction level for each of a plurality of video events. Event listing process 10 may associate 102 an interaction ranking with each of the plurality of video events based upon the relative viewer interaction level for each of the plurality of video events. Event listing process 10 may also generate 104 a video event listing, generally contemporaneously with the plurality of video events, in which the video event listing may be based upon, at least in part, the associated interaction ranking of each of the plurality of video events.

For example, a multitude of viewers (e.g., including user 44, user 46, and user 48) may consume various video events at generally the same time. The video events may, for example, include a plurality of generally contemporaneous television video events (e.g., which may include live, generally simultaneous television events), web-based television events, contemporaneously viewed pre-recorded video events, or other generally contemporaneously video events. That is, in one example, the viewers may be watching various television events occurring at generally the same time (e.g., 9:00 pm on a given Monday evening), or overlapping times (e.g., a one hour program, airing from 9:00 pm to 10:00 pm may overlap a half hour program airing from 9:00 pm to 9:30 pm; as well as a two hour program airing from 8:00 pm to 10:00 pm).

While watching the various generally contemporaneous video events, at least a portion of the viewers may interact with (e.g., using client applications, such as client applications 24, 26, 28) one or more web pages (e.g., web pages 20) which may be associated with one or more of the plurality of video events respectively being watched by the viewers. For example, web pages 20 may include one or more web pages associated with each of one or more of the generally contemporaneous video events. Continuing with the example of video events in the general time frame of 9:00 pm on Monday evening, web pages 20 may include one or more web pages associated with each of the programs “Dancing with the Stars” airing on the ABC network, “Two and a Half Men” airing on the CBS network, and “24” airing on the Fox network. Web pages 20 may include web pages of a single web site and/or may include web pages of more than one separate web site.

The web pages associated with each respective video event (e.g., with each respective television shown, in the above example) may, for example, include information about the respective show, such as, but not limited to, episode synopsis, cast biographies, commentary from the producer and/or cast regarding the show in general and/or regarding the particular episode airing in the contemporaneous time slot. Additionally, the web pages associated with each respective video event may facilitate social interaction between a plurality of viewers. For example, the web pages associated with each respective video event may allow viewers to post comments regarding the associated video event to the web pages, which may be viewed by other viewers (via the associated web page), responded to, and the like. Additionally, viewers may be able to engage in messaging (e.g., such as instant messaging, voice over IP, video over IP, etc.) with other viewers of the video event via the associated web pages. Further the web pages associated with each respective video event may support social gaming elements, and the like. The various content and capabilities provided by the one or more web pages may be centered (e.g., from a content perspective) around the respective associated video event.

Continuing with the above stated example, assume that during the 9:00 pm, Monday evening time frame (e.g., a time frame during which the above example programs “dancing with the Stars,” “Two and a Half Men,” and “24” air), at least a portion of the viewers of each show may interact with one or more web pages associated with each respective video event. For example, user 46 may watch the video event of “24” on a television (not shown). While watching “24” user 46 may interact with a web page (e.g., one of web pages 20) via computing device 38. For example, user 46 may post a comment to a web page associated with “24,” (e.g., via client application 26, which may post user 46's comment without actually accessing the web page). Similarly, user 44 may, for example, watch the video event of “Dancing with the Stars.” While watching “Dancing with the Stars” user 44 may access a web page associated with the video event of “Dancing with the Stars,” e.g., via client application 24 executed on computing device 36. For example, user 44 may access the web page associated with “Dancing with the Stars” and read various comments posted by other users, commentary from the producers, etc.

Event listing process 10 may determine 100 a relative viewer interaction level (e.g., the interactions of users 44 and 46, as well as various additional viewers) for each of the plurality of video events. Determining 100 the relative viewer interaction level may include, for example, determining respective viewer interactions, e.g., with one or more of web pages 20 associated with respective ones of the plurality of video events. The relative viewer interaction level for each of the plurality of video events may include an absolute number of viewer interactions associated with each of the plurality of video events. Additionally/alternatively, the relative viewer interaction level may for each of the plurality of video events may be the number of interactions associated with each of the plurality of video events by comparison to the number of interactions associated with each of the other video events, and/or by comparison to the total number of interactions associated with all of the plurality of video events. Various additional/alternative measures of relative viewer interaction level may also be utilized depending upon design criteria and user preference.

Further, determining 100 the relative viewer interaction level may be based upon, at least in part, the number of individual viewers conducting interactions associated with each of the plurality of video events. Additionally/alternatively, determining 100 the relative viewer interaction level may be based upon, at least in part, the total number of viewer interactions (e.g., counting each of a plurality of interactions by a single user as being a separate interaction). Accordingly, determining 100 the relative viewer interaction level may be based upon, at least in part, the total number of viewers conducting interactions and/or may be based upon, at least in part, the total volume (e.g., total number) of interactions associated with each video event.

For example, and continuing with the preceeding example, there may be 100,000 viewer interactions with one or more web pages associated with the show “Dancing with the Stars.” Similarly, there may be 75,000 viewer interactions with one or more web pages associated with the show “Two and a Half Men.” Further, there may be 25,000 viewer interactions with web pages associated with the show “24.” As discussed above, the number of viewer interactions may include the number of users conducting interactions associated with each of the plurality of video events, and/or may include the total number of interactions associated with each of the plurality of video events. In such and example, event listing process 10 may determine 100 the relative viewer interaction level for the show “Dancing with the Stars” to be 100,000 (representing the number of interactions associated with the show “Dancing with the Stars”). Further, event listing process may determine 100 the relative viewer interaction level for the show “Dancing with the Stars” to be 0.5 or 50% (e.g., representing the number of interactions associated with the show “Dancing with the Stars” as compared to the total number of interactions for all of the plurality of video events). Still further, event listing process 10 may determine 100 the relative viewer interaction level for the shows “Dancing with the Stars,” “Two and a Half Men,” and “24” to be 4:3:1 (e.g., representing the relative number interactions for each video event as compared to the other video events). Of course, various additional/alternative representations may be utilized for determining 100 the relative viewer interaction level for each of the plurality of video events.

In addition to the relative viewer interaction level being based upon the number of viewer interactions and/or the number of viewers contributing interactions associated with a video event, the relative viewer interaction level may also be based upon, at least in part, various other factors. For example, the relative viewer interaction level may be based upon, at least in part, the type of viewer interaction (e.g., posting content to a web page associated with the video content or simply accessing the web page), viewer ratings of the video event (e.g., which may be posted by viewers onto a web page associated with the video content), as well as various additional/alternative factors.

Event listing process 10 may also associate 102 an interaction ranking with each of the plurality of video events based upon the relative viewer interaction level for each of the plurality of video events. The interaction ranking associated 102 with each of the plurality of video events may be indicative of the relative viewer interaction level associated with each of the plurality of video events. For example, and continuing with the above example, event listing process 10 may associate 102 an interaction ranking with the shows “Dancing with the Stars,” “Two and a Half Men,” and “24” indicating that “Dancing with the Stars” has the highest relative viewer interaction level, and that “Two and a Half Men” has the second highest relative viewer interaction level, and “24” has the third highest relative viewer interaction level.

According to one embodiment, event listing process 10 may associate 102 an interaction ranking with each of the plurality of video events in the form of the determined 100 relative viewer interaction level. Accordingly, and consistent with the above example, event listing process 10 may associate an interaction ranking of “50%” with the show “Dancing with the Stars,” an interaction ranking of “37.5%” with the show “Two and a Half Men,” and a ranking of “12.5%” with the show “24,” consistent with the number of viewer interactions for each video event relative to the total number of viewer interactions for all of the plurality of video events. Additional/alternative rankings based upon relative viewer interaction levels may similarly be utilized.

Additionally, event listing process 10 may associate 102 an interaction ranking with each of the plurality of video events based upon, at least in part, the recentness of the determined 100 viewer interaction level. For example, event listing process 10 may associate 102 an interaction ranking with each of the plurality of video events based upon, at least in part, the determined 100 viewer interaction level for a preceeding defined time period. For example, event listing process 10 may associate 102 an interaction ranking with each of the plurality of video events based upon, at least in part, a relative viewer interaction level for each of the plurality of video events within a five minute sliding window. As such, event listing process 10 may associate 102 an interaction ranking with each of the plurality of video events based upon, at least in part, viewer interaction levels within the preceeding five minutes. The sliding time window of five minutes is intended only for illustrative purposes, and is not considered a limitation of this disclosure as other time windows (e.g., a defined time, such as 10 minutes; or a relative time, such as since the last commercial break) may equally be utilized.

Event listing process 10 may generate 104 a video event listing, generally contemporaneously with the plurality of video events. The video event listing may be based upon, at least in part, the associated interaction ranking of each of the plurality of video events. The generated 104 event listing may include a listing of video event that are airing generally contemporaneously with the generation 104 of the event listing. That is, the video event listing may include a listing of video event that are airing at the time that event listing process 10 generates the video event listing. The video event listing may include a listing of the plurality of video events, with the plurality of video events being ranked according to the associated interaction ranking of each of the plurality of video events. As discussed above, the associated interaction ranking of each of the plurality of video events may be based upon, at least in part, various different factors, such as the number of interactions, viewer ratings, etc. Accordingly, event listing process 10 may generate 104 the video event listing based upon, at least in part, any such factor.

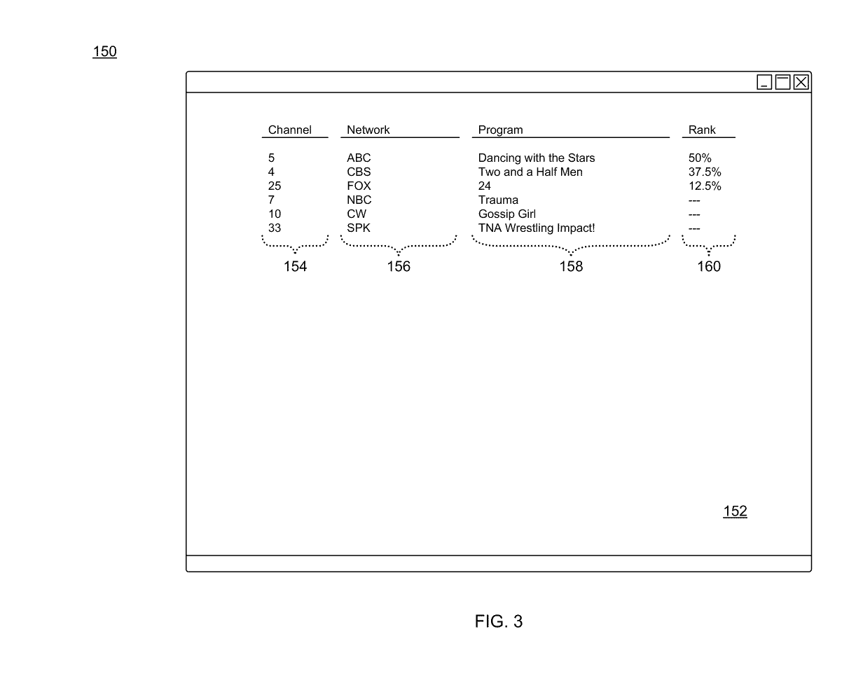

Event listing process 10 may publish 106 the video event listing, thereby making accessible to one or more viewers. In one embodiment, event listing process 10 may publish 106 the video event listing via at least one webpage (e.g., at least one of web pages 20) associated with one or more of the plurality of video events. For example, and referring also to FIG. 3, web page 150 (e.g., which may be included in web pages 20 accessible via webserver application 18) may include event listing 152. Viewers (e.g., user 44) may access event listing using a web browser (e.g., client application 24) executed on a computing device and/or via television/set top box 40/42 (e.g., which may access web page 150 and/or event listing 152 using client application 28.

Event listing 152 may, for example, include channel field 154, including the television channel on which the plurality of video event may be event, network field 156, including a network identifier associated with the plurality of video events, program field 158, including a name identifier of each of the plurality of video events, and rank field 160, including a ranking of the plurality of video events based upon, at least in part, the relative level of viewer interaction. As shown in FIG. 3, the plurality of video events may be listed based upon their respective associated 102 ranking (e.g., in descending order based upon ranking, in the illustrated example). While event listing 152 is shown including four fields (namely channel field 154, network field 156, program field 158, and rank field 160), this is intended for illustrative purposes only, and the number and nature of the fields included in event listing 152 may vary depending upon design criteria and user preference.

In addition to the plurality of video events for which event listing process has determined a relative viewer interaction level, event listing 152 may include one or more video events not having a determined 100 relative viewer interaction level (i.e., non-ranked video events). The name, channel, network, as well as other information about the non-ranked video events may be obtained, e.g., based upon a video event schedule that may be provided by a service provider, a third party, etc. The non-ranked video events may be included within event listing 152 based upon any desired (e.g., predetermined, user-preference based, etc.) schema. For example, the non-ranked video events may be included within event listing 152 in ascending order based upon the channel on which each non-ranked video event is aired.

Based upon, at least in part, the included ranking (e.g., in rank field 160 of broad cast listing 152) of each of the plurality of video events, viewers may be provided with additional information for making viewing decisions. For example, while making viewing decisions, a viewer having an interest in interactions associated with the video event may be able to determine which video events have the most significant viewer interactions. The knowledge of which video events have the most significant viewer interactions may inform a viewers choice in selecting a video event to watch.

Event listing process 10 may update 108 the interaction ranking associated with each of the plurality of video events. For example, overtime the relative viewer interaction level associated with each of the plurality of video events may change. For example, viewer interactions associated with one video event may increase over time and viewer interactions associated with another video event may decrease over time, as well as viewer interactions associated with a video event concluding in the event of the video event ending. As described above, event listing process 10 may associate 102 an interaction ranking with each of the plurality of video events based upon, at least in part, a sliding time window. As such, as the determined 100 relative viewer interaction level associated with each of the plurality of video event contained within the sliding time window changes, event listing process 10 may update 108 the interaction ranking associated with each of the plurality of video events accordingly.

Event listing process 10 may further generate 104 an updated video event listing based upon, at least in part, the updated 108 interaction ranking associated with each of the plurality of video events. Event listing process 10 may generate 104 the updated video event list as described above, however, the updated video event list may be based upon, at least in part, the updated 108 interaction ranking associated with each of the plurality of video events.

A number of implementations have been described. Nevertheless, it will be understood that various modifications may be made. Accordingly, other implementations are within the scope of the following claims.

What is claimed is:

1. A computer implemented method comprising:
determining, by a computing device, a relative viewer interaction level for each of a plurality of video events;
associating, by the computing device, an interaction ranking with each of the plurality of video events based upon the relative viewer interaction level for each of the plurality of video events, and
generating, by the computing device, a video event listing, generally contemporaneously with the plurality of video events, the video event listing based upon, at least in part, the associated interaction ranking of each of the plurality of video events.

2. The computer implemented method according to claim 1, wherein the plurality of video events include a plurality of generally contemporaneous television video events.

3. The computer implemented method according to claim 1, wherein the viewer interaction includes viewer interaction on one or more webpages associated with one or more of the plurality of video events.

4. The computer implemented method according to claim 3, wherein the viewer interaction includes accessing the one or more webpages associated with one or more of the plurality of video events.

5. The computer implemented method according to claim 3, wherein the viewer interaction includes social interaction between a plurality of viewers on the one or more webpages associated with one or more of the plurality of video events.

6. The computer implemented method according to claim 1, further comprising publishing, by the computing device, the video event listing via at least one webpage associated with one or more of the plurality of video events.

7. The computer implemented method according to claim 1, further comprising updating the interaction ranking associated with each of the plurality of video events; and generating an updated video event listing based upon, at least in part, the updated interaction ranking associated with each of the plurality of video events.

8. A computer program product comprising a computer readable medium having a plurality of instructions stored thereon, which, when executed by a processors, cause the processor to perform operations comprising:
determining a relative viewer interaction level for each of a plurality of video events;
associating an interaction ranking with each of the plurality of video events based upon the relative viewer interaction level for each of the plurality of video events, and
generating a video event listing, generally contemporaneously with the plurality of video events, the video event listing based upon, at least in part, the associated interaction ranking of each of the plurality of video events.

9. The computer program product according to claim 8, wherein the plurality of video events include a plurality of generally contemporaneous television video events.

10. The computer program product according to claim 8, wherein the viewer interaction includes viewer interaction on one or more webpages associated with one or more of the plurality of video events.

11. The computer program product according to claim 10, wherein the viewer interaction includes accessing the one or more webpages associated with one or more of the plurality of video events.

12. The computer program product according to claim 10, wherein the viewer interaction includes social interaction between a plurality of viewers on the one or more webpages associated with one or more of the plurality of video events.

13. The computer program product according to claim 8, further comprising instructions for publishing the video event listing via at least one webpage associated with one or more of the plurality of video events.

14. The computer program product according to claim 8, further comprising instructions for updating the interaction ranking associated with each of the plurality of video events; and generating an updated video event listing based upon, at least in part, the updated interaction ranking associated with each of the plurality of video events.

15. A system comprising:
a processor;
a memory coupled with the processor;
a first software module executable by the processor and the memory, the first software module configured to determine a relative viewer interaction level for each of a plurality of video events;
a second software module executable by the processor and the memory, the second software module configured to associate an interaction ranking with each of the plurality of video events based upon the relative viewer interaction level for each of the plurality of video events, and
a third software module executable by the processor and the memory, the third software module configured to generate a video event listing, generally contemporaneously with the plurality of video events, the video event listing based upon, at least in part, the associated interaction ranking of each of the plurality of video events.

16. The system according to claim 15, wherein the plurality of video events include a plurality of generally contemporaneous television video events.

17. The system according to claim 15, wherein the viewer interaction includes viewer interaction on one or more webpages associated with one or more of the plurality of video events.

18. The system according to claim 17, wherein the viewer interaction includes accessing the one or more webpages associated with one or more of the plurality of video events.

19. The system according to claim 17, wherein the viewer interaction includes social interaction between a plurality of viewers on the one or more webpages associated with one or more of the plurality of video events.

20. The system according to claim 15, further comprising a fourth software module executable by the processor and the memory, the fourth software module configured to publish the video event listing via at least one webpage associated with one or more of the plurality of video events.

21. The system according to claim 15, further comprising a fifth software module executable by the processor and the memory, the fifth software module configured to update the interaction ranking associated with each of the plurality of video events; and generating an updated video event listing based upon, at least in part, the updated interaction ranking associated with each of the plurality of video events.
